(19) United States
(12) Patent Application Publication
(10) Pub. No.: US 2026/0028116 A1
(43) Pub. Date: Jan. 29, 2026

(54) PROPELLER FOR AN AIRCRAFT TURBINE ENGINE

(71) Applicant: SAFRAN AIRCRAFT ENGINES, Paris (FR)

(72) Inventors: Clement COTTET, Moissy-Cramayel (FR); Laurent JABLONSKI, Moissy-Cramayel (FR); Regis Eugene Henri SERVANT, Moissy-Cramayel (FR); Timothee Jean Marie LALOY, Moissy-Cramayel (FR); Mouhsine AABI, Moissy-Cramayel (FR)

(21) Appl. No.: 18/995,677

(22) PCT Filed: Aug. 7, 2023
(86) PCT No.: PCT/FR2023/051248

§ 371 Date: Jan. 16, 2025

(30) Foreign Application Priority Data
Aug. 9, 2022 (FR) 2208200

(51) Int. Cl. B64C 11/06; B64C 11/18; B64C 11/32

(52) U.S. Cl. CPC B64C 11/06; B64C 11/18; B64C 11/32

(57) ABSTRACT

A propeller for an aircraft turbine engine having a hub, vanes, bearings for guiding the roots of the vanes into orifices in the hub, and systems for retaining the roots of the vanes in the orifices in the hub along the pitch axis, this system for retaining the root including a ring configured to be fitted in a groove in the root, and a screw-nut system mounted on the root between the ring and one of the bearings.

### TECHNICAL FIELD OF THE INVENTION

The present invention relates to the field of the aircraft turbine engines and in particular to the propulsion propellers of these turbine engines which comprise variable pitch vanes.

### TECHNICAL BACKGROUND

The state of the art comprises in particular the documents FR-A1-3 017 163, FR-A1-3 080 322, WO-A1-2022/018355, US-A1-2017/313404, FR-A1-3 098 789 and WO-A1-2022/018353.

An aircraft turbine engine propeller can be ducted, as in the case of a fan for example, or unducted, as in the case of an open-rotor architecture for example.

A propeller is made up of variable-pitch vanes. The turbine engine then comprises a mechanism allowing for changing the pitch angle of the vanes in order to adapt the thrust generated by the propeller to different phases of flight.

The design of a propeller vane involves several disciplines with generally conflicting objectives. It must allow optimal aerodynamic performance (i.e. provide a thrust while maximising the efficiency), guarantee a mechanical strength of the vane (i.e. withstand the mechanical constraints resulting from static and dynamic loadings) while limiting the mass and the acoustic signature. In particular, the improvement in the aerodynamic performance of the propeller tends towards an increase of the BPR (By Pass Ratio), which translates into an increase in its external diameter and therefore in the span of the vanes. However, the increase in the BPR goes hand in hand with a reduction in the FPF (Fan Pressure Ratio). Therefore, a pitch change system (variable pitch vane) is usually required to make the propeller operable throughout the flight domain.

There are several technologies for attaching a variable pitch propeller vane and several technologies for controlling the angular pitch of such a propeller vane.

A propeller generally comprises a hub which carries systems for retaining the vanes and controlling the angular pitch of its vanes. The hub has a generally annular or polygonal shape around a first axis, which is the longitudinal axis of the turbine engine, and comprises orifices distributed around this first axis and in which the roots of the vanes and the aforementioned systems are housed.

Each of these orifices has a substantially radial orientation with respect to the first axis and receives bearings for guiding the root of a vane about a second axis radial with respect to the first axis, and which is a pitch axis for the corresponding vane.

In the present invention, each of the vanes of the propeller comprises a blade connected to a root, the root of each vane being mounted in one of the orifices in the hub and in the bearings of this orifice, and being held in this orifice by a retaining system. Each root is also associated with a system for controlling its angular pitch.

The orifices in the hub designed to receive the roots of the vanes pass through in the radial direction so as to allow the propeller and, in particular, the guide bearings to be mounted according to a particular kinematics.

According to this kinematics, the root of each vane is fitted in the corresponding orifice of the hub by translation along the pitch axis of this vane, radially from the outside towards the inside with respect to the first axis. The root of the vane is then connected to the control system, which can be housed inside the hub.

The main technical problems with this technology are due to the root of the vane, which is integral with the blade.

This gives rise, for example, to a weight problem linked to the number of parts in the retaining system of the root of the vane. To be able to dismantle the vane independently of the guide bearings, a large number of parts and interfaces are required. This high number of parts results in a high weight and a certain complexity in assembly. On the contrary, a reduction in propeller mass is sought in order to reduce fuel consumption and therefore protect the environment and limit the impact on global warming.

Another problem is the accessibility of its system for retaining and preloading the root of the vane. In fact, the retaining system must ensure a certain preload of the root along the pitch axis. The retaining system is not easily accessible, and generally requires the use of bulky and complex tooling for its assembly, making the vane assembly/disassembly method very complex.

The invention provides a solution to at least some of these technical problems.

### SUMMARY OF THE INVENTION

The invention relates to a propeller for an aircraft turbine engine, this propeller comprising;
a hub extending around a first axis and comprising orifices distributed around this first axis, each of these orifices having a substantially radial orientation with respect to said first axis and passing through said hub,
vanes each comprising a blade and a root, the roots of the vanes being respectively fitted in the orifices of the hub and each of the vanes comprising a substantially radial pitch axis with respect to said first axis,
bearings for guiding the roots of the vanes in the orifices of the hub about said pitch axes, the root of each of the vanes being guided by at least two bearings, radially external and internal respectively with respect to said first axis, mounted around the root and inside the corresponding orifice of the hub, and
systems for retaining the roots of the vanes in the orifices of the hub along said pitch axes,

characterised in that the root of each of the vanes is configured so as to be fitted in the corresponding orifice of the hub by translation along the pitch axis of this vane, radially from the outside towards the inside with respect to said first axis, inside the external and internal bearings, the root of each of the vanes comprising:
an abutment configured to rest in the direction of the pitch axis on the external bearing in order to retain the vane radially inwards with respect to the first axis,
an annular groove extending around the pitch axis and oriented radially outwards with respect to this pitch axis, the groove being located radially inside the abutment with respect to said first axis, and

and in that the system for retaining the root of each of the vanes comprises:
a ring, preferably sectorized, configured to be fitted in the groove of the root of the vane, and
annular screw-nut assembly comprising an internal screw comprising an external thread, and an external nut comprising an internal thread for screwing onto the external thread of the internal screw, the internal screw being configured to be mounted around the root, between the abutment and the groove, and to rest in the direction of the pitch axis on the ring on the side opposite the blade, and the external nut being configured to rest in the direction of the pitch axis on the internal bearing on the side of the blade of the vane in order to retain the vane radially outwards with respect to the first axis.

The invention thus offers a relatively simple configuration of the system which ensures that the root of the vane is retained in the orifice of the hub. On the side of the blade of the vane, the root of the vane comprises an abutment that rests directly or indirectly on the external bearing, which is advantageously mounted before the root is inserted into the orifice of the hub. On the side of the blade of the vane, the root of the vane comprises a groove in which a ring, preferably sectorized, is attached. The simple cooperation by abutment of the ring with the side walls of the groove, in the direction of the pitch axis, is sufficient to hold the ring in the groove. Advantageously, this ring can form an additional abutment for the vane root, which is this time attached to the root. The root of the vane also comprises a zone for receiving the screw-nut assembly, which may, for example, take the form of an external cylindrical surface or an external thread. This screw-nut assembly has the advantage of a dual function and a limited number of parts. The internal screw is screwed onto the root and cooperates by abutment with the ring, which ensures that the root is retained radially outwards with respect to the first axis. This may also enable the ring to be immobilised axially in the groove, along the pitch axis, or even to be locked radially in the groove with respect to this axis. The external nut is screwed onto the internal screw and cooperates with the internal bearing by abutment. The root of the vane is therefore held by the external and internal bearings, by means of the abutment on the one hand, and by means of the ring and the screw-nut assembly on the other.

The number of parts in the retention system of the root is therefore relatively limited, as it can comprise just three parts, namely the ring and the two parts of the screw-nut assembly.

The root is also connected to a system for controlling its angular pitch.

The propeller according to the invention may comprise one or more of the following characteristics, taken in isolation from each other, or in combination with each other:
the ring is sectorized into two pieces and comprises two half-rings;
the ring comprises an internal periphery housed in the groove and an external periphery located outside the groove and on which the internal screw rests;
the internal periphery of the ring comprises an annular rim located on the side of the blade which is intended to cooperate by resting on the internal screw to prevent the ring from accidentally coming out of the groove;
the internal screw comprises an annular rim which is located on the opposite side to the blade and which extends around the external periphery of the ring to prevent the ring from accidentally coming out of the groove;
the internal screw and the external nut each comprise a series of teeth oriented radially outwards with respect to the pitch axis;
the series of teeth of the external nut is located on the side of the blade of the vane, and the series of teeth of the internal screw is located on the opposite side to the blade of the vane;
the propeller also comprises an internal annular cowl which is mounted around the root and at least partially covers the internal bearing and/or the screw-nut assembly;
the internal cowl comprises at least two teeth which are configured to cooperate by fitting with the series of teeth of the screw-nut assembly in order to immobilise them in rotation about the pitch axis;

the internal cowl has its external periphery resting on the hub in the direction of the pitch axis, for example by means of an annular seal;

the internal cowl comprises an internal cylindrical centring surface which is configured to cooperate with a complementary external cylindrical surface of the internal bearing, and for example of an internal ring element of this internal bearing;

the centring surface is located at the internal periphery of an internal annular web of the internal cowl, this web comprising through orifices for the passage of fluid and in particular lubrication oil of the bearings;

the root of each of the vanes comprises a further external thread located at an end of the root opposite the blade, the retaining system of the root of each of the vanes further comprising a threaded ring element which is screwed onto this further external thread;

the threaded ring element is resting in the direction of the pitch axis on an internal periphery of the internal cowl, directly or via an annular seal;
the root of each of the vanes comprises an internal recess which opens radially inwards with respect to the first axis and which comprises internal splines extending around the pitch axis, the propeller further comprising a pitch control system which is associated with the root of each of the vanes, the control system comprising an eccentric, a bushing of which is fitted by translation in the direction of the pitch axis inside the recess, this bushing comprising external splines configured to be fitted in the internal splines of the root;

the bushing comprises an external annular rim, and the threaded ring element comprises an internal annular rim which rests on the external rim of the bushing, and on the side of the blade to retain the bushing in the recess of the root;

the abutment of the root of each of the vanes rests directly on the external bearing, or rests on the external bearing via an external annular cowl which is mounted around the root and at least partly covers the external bearing;

the external cowl has its internal periphery clamped between the abutment and the external bearing, and its external periphery resting on the hub in the direction of the pitch axis, for example via an annular seal;
the external bearing comprises an external ring element which rests in the direction of the pitch axis and on the side opposite to the blade on an abutment located in the orifice of the hub, and/or the internal bearing comprises an external ring element which rests in the direction of the pitch axis and on the same side as the blade on an abutment located in the orifice of the hub;
the external bearing comprises an internal ring element which rests, in the direction of the pitch axis and on the side opposite the blade, on a spacer mounted around the root and in the orifice of the hub, and/or the internal bearing comprises an internal ring element which rests, in the direction of the pitch axis and on the side of the blade, on an abutment on the root of the vane or on the aforementioned spacer;
the internal ring element of the external bearing is resting on the spacer by means of an annular seal, and/or the internal ring element of the internal bearing is resting on the abutment or on the spacer by means of an annular seal;
the bearings have internal diameters which increase radially from the inside to the outside with respect to said first axis; thus, the internal diameter of the (radially) internal bearing has an internal diameter which is smaller than the internal diameter of the (radially) external bearing;
the screw-nut assembly is mounted on an external cylindrical surface of the root; alternatively, the internal screw also comprises an internal thread for screwing onto an external thread of the root;
the bearings are rolling bearings, for example ball or roller bearings; the rollers may be tapered.

The present invention also relates to a turbine engine, in particular for an aircraft, comprising at least one propeller as described above.

The present invention finally relates to a method for mounting a propeller as described above, in which it comprises the steps of:
a) mounting the bearings in the orifices in the hub,
b) inserting the root of each vanes into the corresponding orifice of the hub, radially from the outside towards the inside with respect to said first axis, until the abutment of the root rests on the external bearing,
c) mounting the screw-nut assembly on the root of the vane, between the abutment and the groove,
d) mounting the sectorized ring in the groove of the root,
e) positioning the screw-nut assembly, and in particular the internal screw, so that the internal screw rests on the sectorized ring,
f) screwing the external nut onto the internal screw, so that the external nut rests on the internal bearing.

Advantageously, the external cowl is mounted on the external bearing between steps a) and b).

Advantageously, the spacer is mounted in each of the orifices during step a).

Advantageously, the method also comprises, after step f), a step g) of mounting the internal cowl.

Advantageously, the method also comprises, after step f), a step h) for mounting the control system, followed by a step i) for mounting the threaded ring element.

### BRIEF DESCRIPTION OF THE FIGURES

Further characteristics and advantages will be apparent from the following description of a non-limiting embodiment of the invention with reference to the appended drawings wherein:

FIG. 1 is a schematic axial sectional view of a propeller according to the invention for an aircraft turbine engine,

FIG. 2 is a larger scale view of part of FIG. 1 and shows the root of a vane mounted in an orifice in a hub of the propeller,

FIG. 3a is an even larger scale view of part of FIG. 2 and systems for retaining and controlling the vane root,

FIG. 3b is a view similar to that of FIG. 3a and illustrating an alternative embodiment of the invention,

FIG. 4 is a view similar to FIG. 2 and illustrating an alternative embodiment of the invention,

FIG. 5 is a view similar to that of FIG. 2 and illustrating another embodiment of the invention,

FIG. 6 is a partial schematic axial section and perspective view of the hub and system for retaining the vane root of the alternative embodiment shown in FIG. 5,

FIG. 7 is a partial schematic axial section and perspective view of the hub, retaining system and vane root of the alternative embodiment shown in FIG. 5,

FIG. 8 is a schematic partial axial section and perspective view of the hub, the retaining system, the vane root and a threaded ring element of the control system of the alternative embodiment shown in FIG. 5,

FIG. 9 is a schematic perspective view of a double nut and internal cowl for a propeller according to the invention,

FIG. 10 is a schematic perspective view of the double nut and an axial section of the internal cowl shown in FIG. 9.

### DETAILED DESCRIPTION OF THE INVENTION

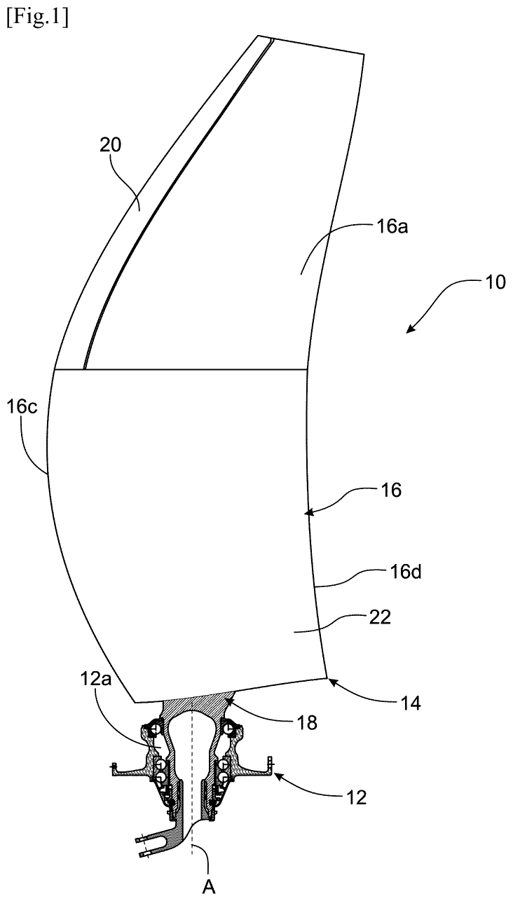

FIG. 1 shows a propeller 10 for an aircraft turbine engine, this propeller 10 being either ducted or unducted.

The propeller 10 comprises a hub 12 and vanes 14 supported by this hub 12.

The hub 12 is generally annular or polygonal in shape and extends around a first axis not shown.

In FIG. 1, one of the vanes 14 of the propeller 10 is visible and the hub 12 is seen in axial section, the section plane passing through the first axis of the hub 12.

The hub 12 comprises orifices 12a distributed around the first axis, each of these orifices 12a having a substantially radial orientation with respect to this first axis. Each orifice 12a passes radially through the hub 12, i.e. each orifice 12a opens radially outwards and radially inwards respectively.

The vanes 14 each comprise a blade 16 and a root 18. The roots 18 of the vanes 14 are respectively fitted in the orifices 12a of the hub 12.

The blade 16 has an aerodynamic profile and comprises a pressure side 16a and a suction side (not visible) which are connected by an upstream leading edge 16c and a downstream trailing edge 16d, the terms upstream and downstream referring to the flow of gases around the blade 16 in operation.

The blade 16 has an upper end which is free, referred to as top, and a lower end which is connected to the root 18.

The vane 14 can be made from a composite material using an injection method known as RTM (Resin Transfer Molding). This method involves preparing a fibrous preform by three-dimensional weaving, then placing this preform in a mould and injecting a polymerisable resin, such as an epoxy resin, which will impregnate the preform. After polymerisation and hardening of the blade 16, its leading edge 16c is generally reinforced by a metal shield 20 which is attached and fixed, for example by gluing.

The shield 20 may be made of titanium or a titanium alloy, stainless steel, steel, aluminium, nickel, etc. The pressure side 16a or even the suction side of the blade 16 may be covered with a polyurethane film 22 for protection against erosion.

A is the axis of elongation of the vane 14 and the blade 16 and in particular the pitch axis of the vane 14, i.e. the axis about which the angular position of the vane 14 is adjusted. In general, this is also a radial axis which extends along a radius in relation to the first axis.

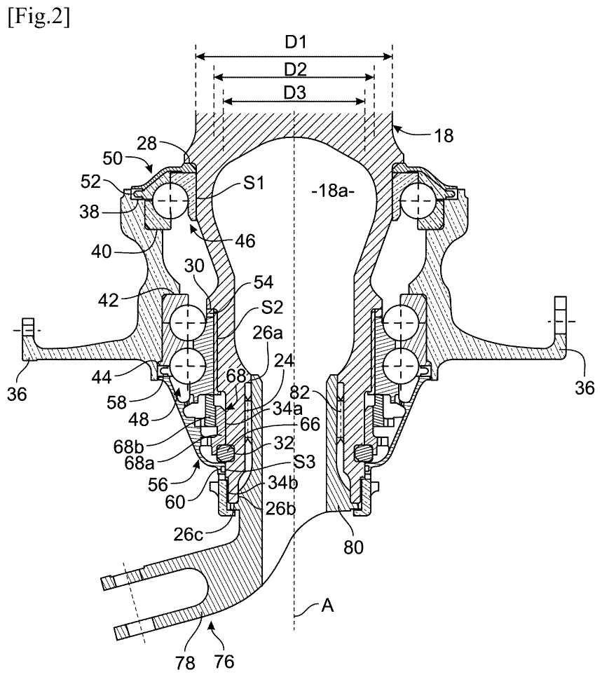

As can be seen in FIG. 2, the root 18 is hollow and comprises an internal recess 18a in the example shown. The root 18 has an elongated, tubular shape, its internal recess 18a being closed on the side facing the blade 16 and open on the side facing away from the blade 16.

The recess 18a in the root 18 reduces its mass, the shape and dimensions of the root 18 being optimised to ensure that the vane 14 holds its shape during operation.

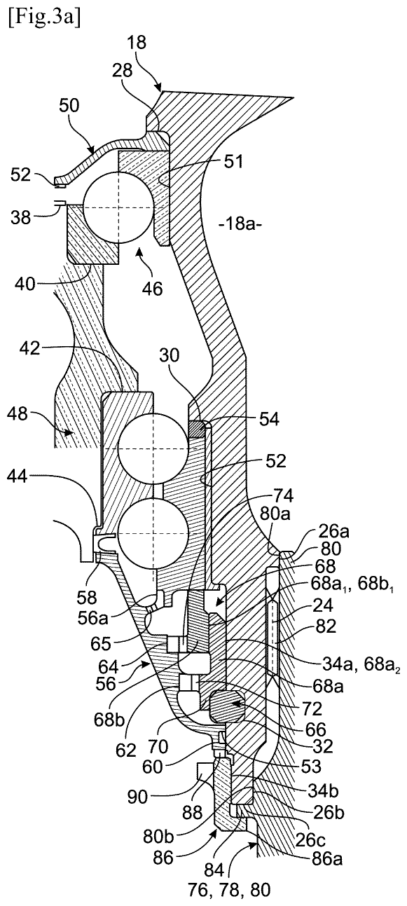

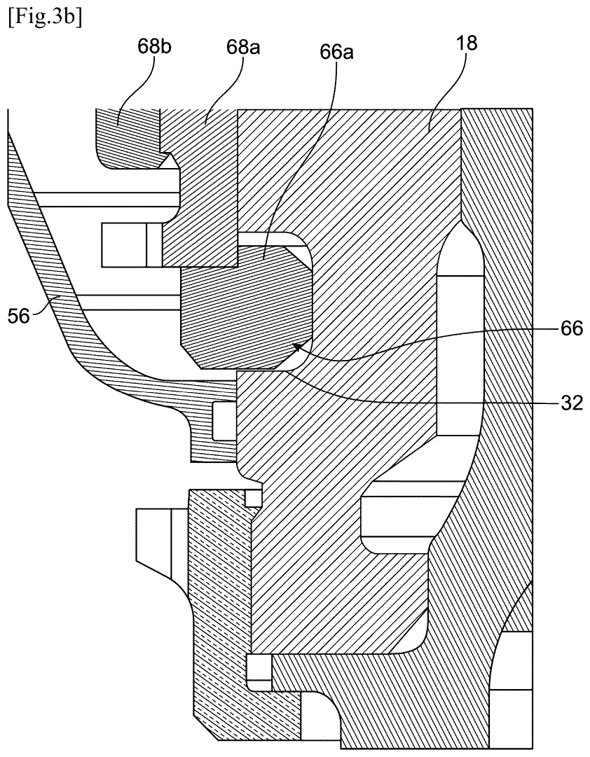

The root 18 has internal splines 24 in its recess 18a, which are configured to enable the root 18 to be coupled to a system for controlling the pitch of the vane about its pitch axis A (FIGS. 2 and 3a).

The splines 24 extend around the axis A. In the example shown, they are located between two internal cylindrical surfaces 26a, 26b of the recess 18a, located respectively radially outside and inside the splines 24 with respect to the first axis.

The root 18 of the vane 14 also comprises, at its radially internal free end (with respect to the first axis), an annular surface 26c which extends in a plane perpendicular to the axis A.

The root 18 of the vane 14 comprises one or more abutments 28, 30. The or each abutment 28, 30 has an annular shape and extends around the axis A and radially outwards with respect to this axis A.

In the example shown, the abutment 28 is formed projecting from a radially external end of the root 18 with respect to the first axis, substantially at the level of the closed end of the recess 18a.

The abutment 30 protrudes from a median part of the root 18 with respect to the first axis, located between the abutment 28 and the free end of the root 18.

The root 18 of the vane 14 also comprises an annular groove 32 which opens radially outwards and which is formed here in the vicinity of the free end of the root 18.

Between the abutment 28 and the groove 32, and more particularly between the abutment 30 and the groove 32, the root 18 comprises an external cylindrical surface 34a which may or may not be provided with an external thread.

The root 18 of the vane 14 comprises several external cylindrical centring surfaces S1, S2 and S3 in the example shown. The surfaces S1, S2 and S3 have decreasing diameters D1, D2 and D3 and are distributed along the axis A, radially from the outside towards the inside with respect to the first axis.

The surface S1 with the largest diameter D1 is located between the abutments 28, 30.

The surface S2 of intermediate diameter D2 is located between the abutment 30 and the surface 34a.

The surface S3 of smaller diameter D3 is located between the groove 32 and the free end of the root 18, and more particularly between the groove 32 and another external thread 34b of the root 18. The thread 34b has a smaller diameter than the surface 34a or the thread provided on this surface.

The abutment 28 is located at the radially external end of surface S1 with respect to the first axis. The abutment 30 is located at the radially external end of surface S2 with respect to the first axis.

The hub 12 may comprise annular fixing flanges 36 at each of its axial ends, as shown in FIG. 2.

In the example shown, each of the orifices 12a in the hub 12 comprises abutments 38, 40, 42, 44.

The or each abutment 38, 40, 42, 44 is annular in shape and extends around the axis A and radially inwards with respect to this axis A.

The abutments 38, 40, 42, 44 are respectively arranged one after the other along the pitch axis A. There is thus a radially external abutment 38, a radially internal abutment 44 and two intermediate abutments 40, 42.

The abutment 38 has a larger diameter than the abutment 40, and the abutment 44 has a larger diameter than the abutment 42.

The intermediate abutments 40, 42 accommodate bearings 46, 48 for guiding the roots 18 of the vanes 14.

The bearings 46, 48 are two in number and are mounted in the orifice 12a of the hub, one radially outside the other. The external bearing 46 refers to the bearing located radially on the outside, and the internal bearing 48 refers to the bearing located radially on the inside.

The bearings 46, 48 are mounted inside the orifice 12a, resting axially (with respect to the axis A) on the intermediate abutments 40, 42. The bearings 46, 48 are mounted around the root 18, and in particular around surfaces S1 and S2, resting axially (with respect to axis A) on the abutments 28, 30.

Advantageously, an intermediate part is provided between the bearing 48 and the vane root 18, and in particular between the internal ring element of the bearing 48 and the surface S2. This is a shrink disc mounted tightly on the vane root 18, allowing a harder material than that (e.g. titanium) of the root 18 to be used as a bearing seat. In fact, the internal ring element of the bearing 48 cannot have a significant shrink fit on its axis, as it is displaced during preloading. Therefore, to avoid a fretting phenomenon (material tearing that would result in a break initiation on the vane root), this hard intermediate part can be added.

The external bearing 46 is configured to be fitted in the orifice 12a from the outside of the hub 12, moving it radially from the outside towards the inside, until it comes to rest on the abutment 40. In this case, the bearing 46 is an angular contact ball bearing and it is its external ring element that is supported on the abutment 40.

The internal bearing 48 is configured to be fitted in the orifice 12a from the inside of the hub, moving it radially from the inside outwards, until it comes to rest on the abutment 42. In this case, the bearing 48 is a ball bearing, in particular a double-row ball bearing, with angular contact and it is its external ring element which bears on the abutment 42.

As can be seen in FIGS. 2 and 3a, the root 18 of the vane 14 is configured so as to be fitted in the orifice 12a by translation along the axis A, radially from the outside towards the inside with respect to the first axis, inside the bearings 46, 48, until the abutment 28 rests axially (with respect to the axis A) on the bearing 46, and in particular its internal ring element, and the abutment 30 bears axially (with respect to the axis A) on the bearing 48, and in particular its internal ring element. The bearings 46, 48, and in particular their internal ring elements, are then mounted on the surfaces S1 and S2.

It is therefore understood that the external bearing 46 has an internal diameter greater than the internal diameter of the internal bearing 48 to enable the root 18 to be mounted in the orifice 12a, insofar as the bearings 46, 48 are mounted before the root 18 in the example shown.

The abutment 28 on the root 18 can rest directly (along the axis A) on the external bearing 46 and in particular its internal ring element. In the example shown, the abutment 28 rests on the external bearing 46 via an external annular cowl 50 which is mounted around the root and at least partially covers the external bearing 46.

This external cowl 50 has its internal periphery clamped between the abutment 28 and the external bearing 46, and in particular its internal ring element. The external periphery of the cowl 50 rests in the direction of the axis A on the hub 12 and in particular on the abutment 38, either directly or via an annular seal 52 as shown in the drawing.

The abutment 30 of the root 18 can be in direct contact (along the axis A) with the internal bearing 48 and in particular its internal ring element. In the example shown, the abutment 30 rests on the internal bearing 48 via an annular seal 54.

An internal annular cowl 56 can also be mounted around the root 18 and at least partially cover the internal bearing 48.

The internal cowl 56 has its external periphery bearing in the direction of the axis A on the hub 12 and in particular on the abutment 44, either directly or via an annular seal 58 as shown in the drawing. Alternatively, the external periphery of the cowl 56 could rest in this direction on the internal bearing 48, and in particular on the external ring element of this bearing.

The internal periphery of the cowl 56 rests radially with respect to the axis A on the root 18, in the vicinity of its free end, either directly or by means of an annular seal 60 as shown in the drawing.

In the example shown, the internal cowl 56 comprises at least two teeth 62, 64 oriented radially towards the axis A.

The internal cowl 56 may also comprise an internal cylindrical centring surface 56a which is configured to cooperate with a complementary external cylindrical surface of the internal bearing 48, and for example of the internal ring element of this bearing. This surface 56a may be located at the internal periphery of an internal annular web of the cowl 56. This web can comprise through-orifices 65 for the passage of fluids, in particular lubricating oil for the bearings 46 and 48 (FIG. 3a).

The root 18 is held in the orifice 12a of the hub 12 by a retaining system which essentially comprises a ring 66 and a screw-nut assembly 68. It is this screw-nut assembly 68 that allows a preload to be applied to the root of the vane.

The ring 66 is mounted around the root 18 of the vane and extends around the axis A. The ring 66 is sectorised and therefore comprises ring sectors arranged circumferentially end to end around the axis A. The number of sectors is not restrictive and may be limited to two. The ring 66 then comprises two half-rings.

Alternatively, the ring could be continuous and not sectorised. It could then comprise a slot to allow elastic deformation of the ring by spreading its longitudinal ends apart.

The ring 66 is configured to be fitted in the groove 32 of the root 18. It is understood that it is the sectorisation of the ring 66 that enables it to be mounted into the groove 32. The ring 66 comprises an internal periphery housed in the groove 32 and an external periphery intended to remain outside the groove 32 to form an axial abutment (with respect to axis A).

The screw-nut assembly 68 comprises an internal screw 68a and an external nut 68b. The internal screw 68a comprises an external thread 68a1 and may comprise an internal thread 68a2 or instead an internal cylindrical surface. When the screw 68a has an internal cylindrical surface, the latter is intended to cooperate by sliding with the surface 34a of the root when the assembly 68 is mounted and positioned on the root. When the screw 68a comprises an internal thread 68a2, the root comprises a thread on its surface 34a and the thread 68a2 is used to screw the nut 68a onto the thread of the root 18.

The external nut 68b comprises an internal thread 68b1 for screwing onto the external thread 68a1 of the internal screw 68a.

The positioning (by simple sliding or screwing/unscrewing) the internal screw 68a on the root 18 enables it to be moved axially (with respect to the axis A) on the root 18 and to be positioned along the axis A. The screw 68a can be supported in the direction of the axis A on the ring 66 on the side opposite the blade 16.

The screwing/unscrewing of the external nut 68b allows it to be moved axially (with respect to the axis A) on the nut 68a and to be positioned along the axis A. The external nut 68b is able to rest on the direction of the axis A on the internal bearing 48, and in particular on its internal ring element, on the side of the blade 16.

The double support of the screw-nut assembly 68, respectively on the ring 66 and the bearing 48, and the screwing of the external nut 68b on the internal screw 68a, enable a certain preload to be applied to the root 18 of the vane by the retaining system.

In the example shown in FIGS. 2 and 3a, the internal screw 68a comprises an annular rim 70 which is located on the side opposite the blade 16 and which extends around the external periphery of the ring 66 to prevent the ring 66 from accidentally coming out of the groove 32.

In the alternative embodiment shown in FIG. 3b, the internal periphery of the ring 66 may comprise an annular rim 66a located on the side of the blade 16, which is intended to cooperate by resting on the internal screw 68a to prevent the ring 66 from accidentally coming out of the groove 32.

The screw 68a and the nut 68b each comprise a series of teeth 72, 74 oriented radially outwards with respect to the axis A and configured to cooperate with the teeth 62, 64 of the internal cowl 56 in order to immobilise the assembly 68 in rotation about the axis A.

The series of teeth 74 of the external nut 68b is located on the side of the blade 16 and is configured to cooperate with the tooth 64 on the cowl 56. The series of teeth 72 on the internal screw 68a is located on the opposite side to the blade 16 and is configured to cooperate with the tooth 62 on the cowl 56.

In the example shown, the series of teeth 72 has a smaller external diameter than the series of teeth 74.

The propeller 10 also comprises a system 76 for controlling the pitch of the vane 14, which is associated with the root 18 of this vane. The propeller 10 therefore comprises as many control systems 76 as there are vanes 14 of this propeller.

Each control system 76 comprises an eccentric 78, a bushing 80 of which is fitted in translation along the axis A inside the recess 18a of the root 18, radially from the inside towards the outside with respect to the first axis.

The bushing 80 comprises external splines 82 configured to fit with the internal splines 24 of the root 18.

The bushing 80 also comprises external cylindrical centring surfaces 80a, 80b which cooperate with the surfaces 26a, 26b of the recess 18a when the bushing 80 is inserted into the recess 18a. These surfaces 80a, 80b are located on either side of the splines 82 along the axis A.

In the example shown, the bushing 80 also comprises an external annular rim 84 (FIG. 3a).

A threaded ring element 86 is screwed onto the thread 34b of the root, at its free end, and comprises an internal annular rim 86a which rests on the direction of the axis A on the external rim 84 of the bushing 80, and in the direction of the blade 16 to retain the bushing 80 in the recess 18a of the root 18.

The threaded ring element 86 rests in the direction of the axis A on the internal periphery of the internal cowl 56, either directly or via an annular seal 88.

The threaded ring element 86 may comprise a series of teeth 90 extending radially outwards from the axis A, to enable the ring element 86 to be engaged with a tool for screwing and unscrewing the ring element.

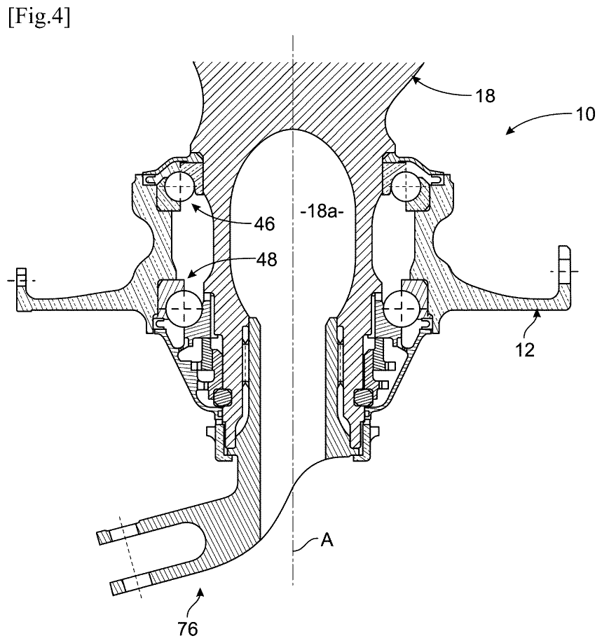

The alternative embodiment shown in FIG. 4 differs from the previous embodiment in that the double-row internal bearing 48 is replaced by a single-row internal bearing 48. This allows the length of the bearing 48 to be reduced along the axis A, and therefore the axial dimensions of the assembly along this axis. The recess 18a in the root 18 also has a different cross-sectional shape.

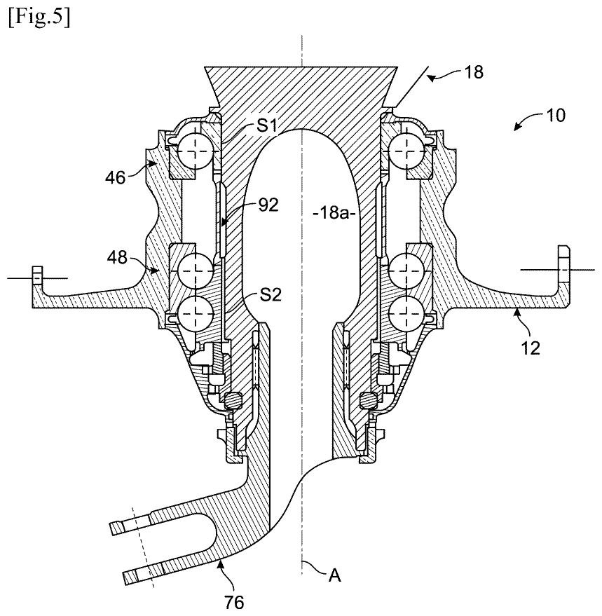

The alternative embodiment shown in FIG. 5 differs from the first alternative embodiment in that the propeller 10 also comprises an annular or tubular spacer 92 which is mounted around the root 18 and between the bearings 46, 48. The spacer 92 extends along the axis A and comprises an end located on the side of the blade 16, which rests axially (along the axis A), directly or via a preload wedge, on the external bearing 46 and in particular its internal ring element.

The preload wedge is calibrated in thickness to allow the correct preload to be exerted on the bearings, so that during operation, the assembly of the rolling elements of the bearings maintain contact with their raceways.

The spacer 92 has an opposite end which rests axially (along the axis A), directly or via an annular seal, on the internal bearing 48 and in particular on its internal ring element.

This alternative embodiment eliminates the abutment 30 and therefore simplifies the design of the root 18. It also means that the surfaces S1 and S2 for receiving the bearings 46, 48 have similar or even identical diameters, which simplifies the design of the root 18.

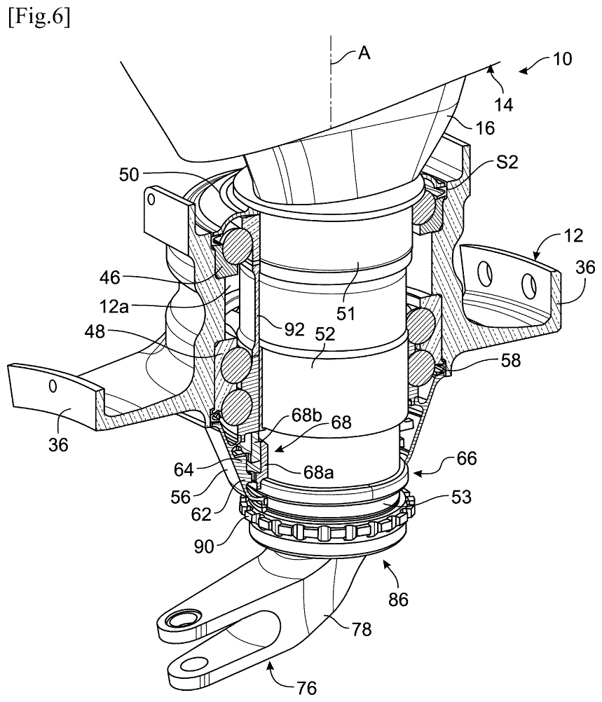

FIG. 6 and following are perspective views of the embodiment shown in FIG. 5, but can also be used to illustrate characteristics of previous embodiments.

FIG. 6, for example, shows the division of ring 66 into two half-rings. It also shows the series of teeth 90 on the threaded ring element 86 and the particular shape of the eccentric 78, which comprises a clevis for connection to a control mechanism not shown.

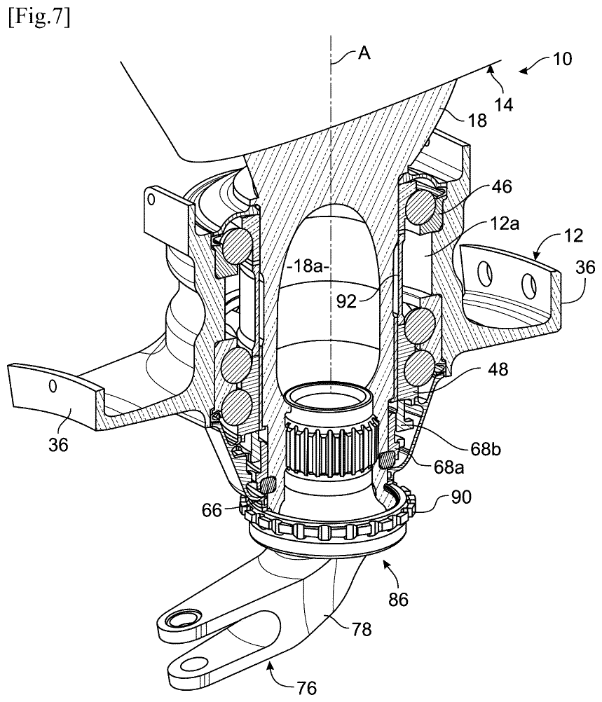

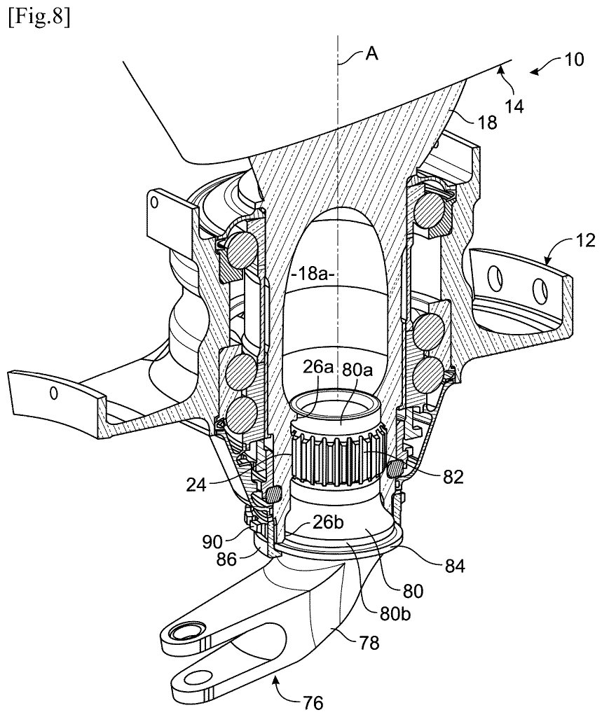

FIG. 7 shows the splines 82 on the bushing 80 and FIG. 8 also shows a cross-section of the threaded ring element 86.

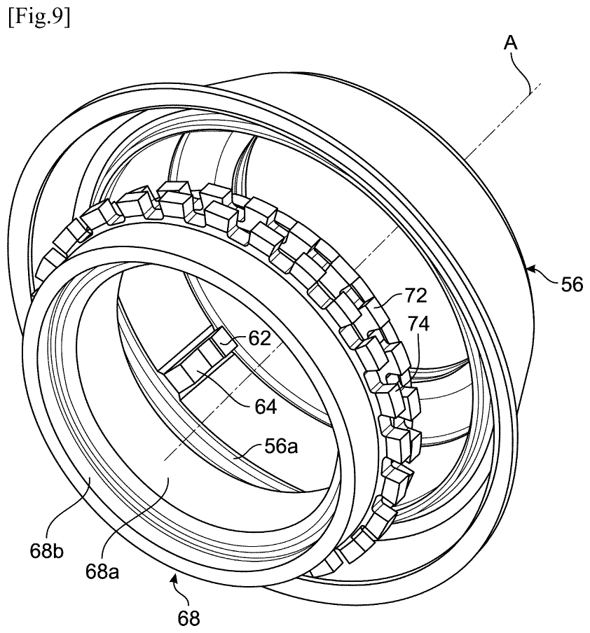

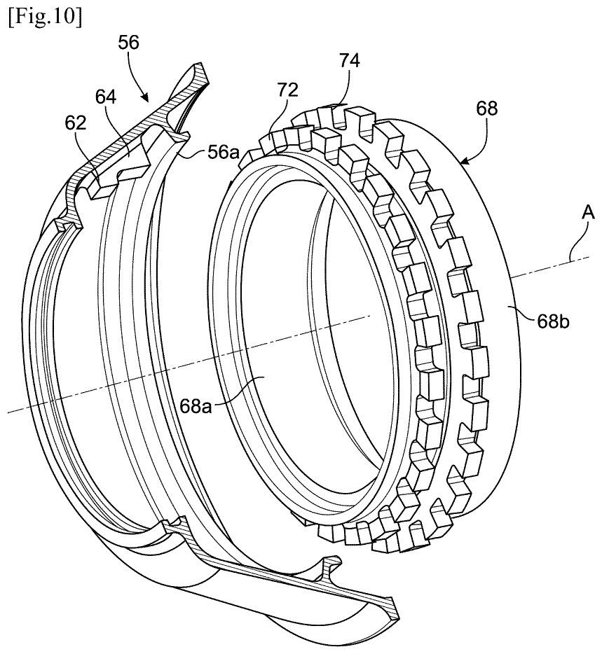

FIGS. 9 and 10 show assembly 68 with its series of teeth 72, 74. They also show the teeth 62, 64 of the cowl 56. The tooth 62 is axially aligned with tooth 64. Alternatively, the cowl 56 could comprise two or more teeth 62 distributed around the axis A, and two or more teeth 64 distributed around the axis A.

In yet another variant not shown, the bearings could be angular contact roller bearings such as tapered roller bearings.

A method of mounting the propeller 10 according to the invention will now be described. This method comprises the following steps, in order, for each of the vanes 14:
a) mounting the bearings 46, 48 in the orifice 12a of the hub 12; as mentioned above, the bearing 48 is fitted from the inside of the hub 12 in the orifice 12a, and the bearing 46 is fitted from the outside of the hub in the orifice 12a.
b) inserting the root 18 of the vane 14 into the orifice 12a, from the outside inwards, until in particular the abutment 28 of the root 18 rests on the external bearing 46 or the previously mounted external cowl 50.
c) mounting the screw-nut assembly 68 on the root 18, between the abutment 28 and the groove 32, either by simple displacement on the surface 34a or by screwing the internal screw onto the thread of this surface 34a,
d) mounting the sectorized ring 68 in the groove 32 of the root 18,
e) positioning or unscrewing the screw-nut assembly 68, and in particular the internal screw 68a, so that the internal screw 68a rests on the sectorized ring 66,
f) screwing the external nut 68b onto the internal screw 68a so that the external nut 68b rests on the internal bearing 48.

In the variant shown in FIG. 5, the spacer 92 is mounted in the orifice 12a, either after the bearing 46 has been mounted and before the bearing 48 has been mounted, or after the bearing 48 has been mounted and before the bearing 46 has been mounted.

After step f), the method may also comprise a step g) of mounting the internal cowl 56.

The method may also comprise, after step f) or even after step g), a step h) for mounting the control system 76, followed by a step i) for mounting the threaded ring element 86.

The invention offers several advantages, including: the elimination of interface parts between the vane, the bearings and the eccentric in order to limit the number of parts and the overall weight, the retention of the vane by the retention ring mounted after the vane has been lowered into the bearings, the retention ring is locked or immobilised by the screw-nut assembly after the preload has been applied, and the retention ring is mounted from inside the hub, giving 360° access for tooling on the nut and preload screw when the eccentric is not mounted.

1. A propeller for an aircraft turbine engine, the propeller comprising;
a hub extending around a first axis and comprising orifices distributed around this first axis, each of these orifices having a substantially radial orientation with respect to said first axis and passing through said hub,
vanes each comprising a blade and a root, the roots of the vanes being respectively fitted into the orifices of the hub and each of the vanes comprising a pitch axis substantially radial with respect to said first axis,
bearings for guiding the roots of the vanes in the orifices of the hub about said pitch axes, the root of each of the vanes being guided by at least two bearings, radially external and internal respectively with respect to said first axis, mounted around the root and inside the corresponding orifice of the hub, and
systems for retaining the roots of the vanes in the orifices of the hub along said pitch axes,
wherein the root of each of the vanes is configured so as to be fitted in the corresponding orifice of the hub by translation along the pitch axis of this vane, radially from the outside towards the inside with respect to said first axis, inside the external and internal bearings, the root of each of the vanes comprising:
an abutment configured to rest in the direction of the pitch axis on the external bearing in order to retain the vane radially inwards with respect to the first axis,
an annular groove extending around the pitch axis and oriented radially outwards with respect to this pitch axis, the groove being located radially inside the abutment with respect to said first axis, and
and in that the system for retaining the root of each of the vanes comprises:
+ a ring, preferably sectorized, configured to be fitted in the groove of the root of the vane, and
+ an annular screw-nut assembly comprising an internal screw comprising an external thread, and an external nut comprising an internal thread for screwing onto the external thread of the internal screw, the internal screw being configured to be mounted around the root, between the abutment and the groove, and to rest in the direction of the pitch axis on the ring on the side opposite the blade, and the external nut being configured to rest in the direction of the pitch axis on the internal bearing on the side of the blade of the vane in order to retain the vane radially outwards with respect to the first axis.

2. The propeller according to claim 1, wherein the ring is sectorized into two pieces and comprises two half-rings.

3. The propeller according to claim 1, wherein the ring comprises an internal periphery housed in the groove and an external periphery located outside the groove and on which the internal screw rests.

4. The propeller according to claim 3, wherein the internal periphery of the ring comprises an annular rim located on the side of the blade which is intended to cooperate by resting on the internal screw to prevent the ring from accidentally coming out of the groove.

5. The propeller according to claim 3, wherein the internal screw comprises an annular rim which is located on the opposite side to the blade and which extends around the external periphery of the ring to prevent the ring from accidentally coming out of the groove.

6. The propeller according to claim 1, wherein the internal screw and the external nut each comprise a series of teeth oriented radially outwards with respect to the pitch axis.

7. The propeller according to claim 6, wherein the series of teeth of the external nut is located on the side of the blade of the vane, and the series of teeth of the internal screw is located on the opposite side to the blade of the vane.

8. The propeller according to claim 1, wherein the propeller further comprises an internal annular cowl which is mounted around the root and at least partially covers the internal bearing and/or the screw-nut assembly.

9. The propeller according to claim 8, wherein the internal screw and the external nut each comprise a series of teeth oriented radially outwards with respect to the pitch axis and the internal annular cowl comprises at least two teeth which are configured to cooperate by fitting with the series of teeth of the screw-nut assembly in order to immobilise them in rotation about the pitch axis.

10. The propeller according to claim 1, wherein the root of each of the vanes comprises an internal recess which opens radially inwards with respect to the first axis and which comprises internal splines extending around the pitch axis, the propeller further comprising a pitch control system which is associated with the root of each of the vanes, the control system comprising an eccentric, a bushing of which is fitted by translation in the direction of the pitch axis inside the recess, this bushing comprising external splines configured to be fitted in the internal splines of the root.

11. The propeller according to claim 1, wherein the external bearing comprises an external ring element which rests in the direction of the pitch axis and on the side opposite the blade on an abutment located in the orifice of the hub, and/or the internal bearing comprises an external ring element which rests in the direction of the pitch axis and on the side facing the blade on an abutment located in the orifice of the hub.

12. The propeller according to claim 1, wherein the external bearing comprises an internal ring element which rests in the direction of the pitch axis and on the side opposite the blade on a spacer mounted around the root and in the orifice of the hub, and/or the internal bearing comprises an internal ring element which rests in the direction of the pitch axis and on the side facing the blade on an abutment on the root of the vane or on the aforementioned spacer.

13. A turbine engine, in particular for aircraft, comprising at least one propeller according to claim 1.

14. A method for mounting a propeller according to claim 1, wherein the method comprises the steps of:
a) mounting the bearings in the orifices in the hub,
b) inserting the root of each of the vanes into the corresponding orifice of the hub, radially from the outside towards the inside with respect to said first axis, until the abutment of the root rests on the external bearing,
c) mounting the screw-nut assembly on the root of the vane, between the abutment and the groove,
d) mounting the sectorized ring in the groove of the root,
e) positioning the screw-nut assembly, and in particular the internal screw, so that the internal screw rests on the sectorized ring, and
f) screwing the external nut onto the internal screw so that the external nut rests on the internal bearing.

15. A method according to claim 14, wherein the propeller further comprises an internal annular cowl which is mounted around the root and at least partially covers the internal bearing and/or the screw-nut assembly, wherein the method further comprises, after step f), a step g) of mounting the internal annular cowl.
